(19) United States
(12) Patent Application Publication
(10) Pub. No.: US 2005/0152504 A1
(43) Pub. Date: Jul. 14, 2005

(54) Method and apparatus for automated tomography inspection

(76) Inventor: Ang Shih, San Jose, CA (US)

Correspondence Address: CARR & FERRELL LLP, 2200 GENG ROAD, PALO ALTO, CA, 94303, US

(21) Appl. No.: 10/757,817

(22) Filed: Jan. 13, 2004

(51) Int. Cl. H05G 1/00

(52) U.S. Cl. 378/210

(57) ABSTRACT

A method for rapid automated inspection of manufactured objects uses tomography to acquire projections of an object and then compares those projections to similar projections obtained from a standard. Variance projections of the variations between the object and standard projections for particular perspectives are generated. Variant portions of the variance projections are identified and used to generate a 3D reconstruction of just the variations between the object and the standard. The 3D reconstruction can then be evaluated to qualify the object. An apparatus of the invention comprises an imaging system in communication with a computer system configured to perform the method.

### BACKGROUND OF THE INVENTION

1. Field of the Invention

The present invention relates generally to the field of tomography and more particularly to a method and apparatus for rapidly inspecting objects by X-ray tomography.

2. Description of the Prior Art

Tomography is a process of generating three-dimensional (3D) maps, or tomographs, of internal structures of objects. A tomograph can show, for example, a precise shape of an object, variations in density or composition, and sizes, locations, and orientations of defects such as cracks, voids, delaminations, and contamination. Such a tomograph is typically generated by irradiating the object from many different perspectives, and for each perspective, mapping an amount of radiation that is transmitted through the object. Thus, a unique image, or projection, of the object is obtained for each perspective. A properly configured computer can generate the tomograph from the projections of the object taken from the various perspectives.

In the case of X-ray tomography, for example, an X-ray source is placed on one side of the object and an X-ray detector is placed directly opposite the X-ray source on the other side of the object. In this way the X-ray detector is configured to receive X-ray radiation that is transmitted through the object. To obtain a projection of the object from a different perspective the X-ray source and X-ray detector are moved in unison to new locations relative to the object while maintaining their fixed relationship to each other. This is commonly achieved by fixing both the X-ray source and the X-ray detector to a common arm that allows both to be translated around a fixed point in space where the object is located.

Each projection of the object is a two-dimensional map of the internal structure of the object as seen from a particular perspective. Since the X-ray source is effectively a point source at a known location, each pixel in the projection represents the intensity of the X-ray beam that was transmitted through the object along a unique line, the line defined between the X-ray source and the location of that pixel on the X-ray detector. Anything along the line that absorbs or deflects X-rays will reduce the X-ray intensity received by the corresponding pixel.

Accordingly, for each pixel of each projection there is a unique line through the object and a corresponding recorded intensity. Therefore, a matrix for each projection can be constructed that represents for each pixel both the recorded intensity and spatial coordinates of the line between the radiation source (i.e., X-ray source) and that pixel. A properly configured computer can numerically solve a system of matrixes to reconstruct a tomograph of the object. It will be appreciated that the resolution of the tomograph depends on factors such as the number of projections and the number of pixels in each projection, and the variation amongst the perspectives of the projections. Likewise, increasing the resolution of the tomograph by increasing either the number of projections or the number of pixels per projection greatly increases computation time required to solve the system of matrixes necessary to generate the tomograph.

Tomography is increasingly finding utility in industrial applications such as for quality control purposes. In these applications, a tomograph of an object is compared to a tomograph obtained from a standard to evaluate any differences. However, obtaining the tomograph of the object can be a very time consuming process as it requires generating a sufficient number of projections of the object followed by all of the computational time necessary to solve the system of matrixes. Once the tomograph of the object has been determined it is compared against the tomograph of the standard to determine the quality of the object. This comparison can also be a lengthy process as the number of points that need to be compared can be quite large. In quality control applications it is desirable to be able to make determinations of quality at least as rapidly as parts are manufactured, else this screening step becomes a bottleneck in the production process.

Therefore, what is needed is a tomographic method and apparatus that can rapidly compare an object to a standard and make a quality determination for automated inspection purposes.

### SUMMARY

A method for producing a variance reconstruction of variations between an object and a standard comprises acquiring object projections of the object from a plurality of different perspectives, generating variance projections from the object projections by comparing the object projections with stored standard projections having corresponding perspectives, and generating the variance reconstruction from the variance projections. Each object projection can include a two-dimensional map of radiation intensity, such as X-ray radiation intensity, and a set of positional data that define the perspective of the object projection. In some embodiments, comparing the object projections with stored standard projections having corresponding perspectives can include determining the differences between the corresponding object and standard projections. The method can further include adjusting registrations of the object projections relative to the standard projections before generating variance projections.

In some embodiments of the method, generating the variance reconstruction from the variance projections can include identifying variant portions of the variance projections. In some of these embodiments, identifying variant portions can include comparing intensity maps of the variance projections to a threshold. Also in some embodiments, identifying variant portions can include describing the locations of the variant portions within the intensity maps. In some of these latter embodiments, describing the location of the variant portion can include identifying pixels that define a perimeter of the variant portion.

The invention also includes a method for automated tomography inspection. This method comprises acquiring object projections of an object from a plurality of different perspectives, generating variance projections from the object projections by comparing the object projections with stored standard projections having corresponding perspectives, and evaluating the variance projections to qualify the object. Generating variance projections can include determining whether a sufficient number of variance projections have been acquired to assess the quality of the object. Evaluating the variance projections to qualify the object can include passing or failing the object, and/or can include grading the object.

Evaluating the variance projections according to this method can also include generating a variance reconstruction of the variations between the object and the standard. In some embodiments, generating the variance reconstruction can include determining variant portions of the variance projections. Also in some embodiments, evaluating the variance projections can include evaluating the variance reconstruction. In some of the latter embodiments, evaluating the variance reconstruction can include identifying defects in the variance reconstruction, and in some of these embodiments, evaluating the variance reconstruction can further include determining a figure of merit from the defects identified in the variance reconstruction.

The invention also provides computer-readable media comprising program instructions. The program instructions can provide for acquiring object projections of an object from a plurality of different perspectives, generating variance projections from the object projections by comparing the object projections with stored standard projections having corresponding perspectives, and generating a variance reconstruction from the variance projections. The program instructions can also provide for acquiring object projections of an object from a plurality of different perspectives, generating variance projections from the object projections by comparing the object projections with stored standard projections having corresponding perspectives, and evaluating the variance projections to qualify the object. In some embodiments, the computer-readable medium can also include program instructions for generating a variance reconstruction of the variations between the object and the standard. Also in some embodiments, the computer-readable medium can include program instructions for determining variant portions of the variance projections, and in some of these embodiments, the computer-readable medium can also include program instructions for generating a variance reconstruction from the variant portions.

Further, the invention also provides an apparatus for producing a variance reconstruction of variations between an object and a standard. The apparatus includes an imaging system in communication with a computer system. The imaging system includes a stage for supporting the object, and a radiation source and a detector adjustably positionable relative to the object to define perspectives thereof. The computer system is configured to acquire object projections of the object from a plurality of different perspectives, generate variance projections from the object projections by comparing the object projections with stored standard projections having corresponding perspectives, and generate the variance reconstruction from the variance projections. In some embodiments, the computer system can be further configured to adjust registrations of the object projections relative to the standard projections having corresponding perspectives. Also in some embodiments the computer system can be further configured to evaluate the variance reconstruction to qualify the object.

### BRIEF DESCRIPTION OF DRAWINGS

FIG. 1 is a schematic representation of an exemplary tomography system according to an embodiment of the invention;

FIG. 2 is a schematic representation of functional components of the computer system of the exemplary tomography system of FIG. 1;

FIG. 3 is a flowchart of an exemplary embodiment of a method of the invention;

FIG. 4 is a schematic representation of exemplary applications for performing the method of FIG. 3; and

FIG. 5 is a schematic representation of an object projection being acquired from an object according to an embodiment of the invention.

### DETAILED DESCRIPTION OF THE INVENTION

An apparatus and method are provided for rapid automated inspection of manufactured objects using tomography. The method acquires projections of an object under inspection and compares those projections to similar projections obtained from a standard. A variance projection shows the variations between the object and standard projections for a particular perspective. Variance projections from different perspectives can be used to create a 3D reconstruction of merely the variations between the object and the standard (a “variance reconstruction”), rather than a complete 3D reconstruction of the entire object. The variance projections or the variance reconstruction can be evaluated to determine, for example, whether the object passes or fails the inspection.

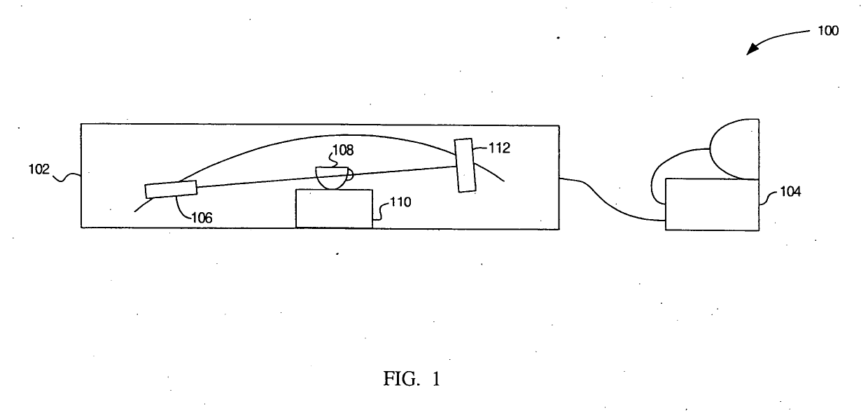

The method of the invention can best be understood in the context of an exemplary system for tomography, shown in FIG. 1. A tomography system 100 comprises an imaging system 102 in communication with a computer system 104. In the exemplary imaging system 102, a radiation source 106 directs radiation at an object 108 on a stage 110 or otherwise fixed in space. Radiation that passes through the object 108 is received by a detector 112 that is configured to spatially resolve the incident radiation into a plurality of pixels. A suitable radiation source 106 produces radiation with a wavelength, or range of wavelengths, that the object is at least partially transparent to, and a suitable detector 112 is capable of detecting that radiation. It will be appreciated, however, that although the invention is illustrated herein with reference to X-ray tomography where the radiation is X-ray radiation, the invention is not limited to X-ray tomography and can work equally well with other penetrating radiations such as gamma rays.

In some embodiments, the radiation source 106 and the detector 112 are held in a fixed relationship to one another and may be translated together around a location in space that is preferably within, or near to, the object 108. In other embodiments, the radiation source 106 and the detector 112 can move independently of one another. Each configuration of the radiation source 106 and of the detector 112 relative to the object 108 constitutes a particular perspective. Any translation of the object 108, the radiation source 106, or the detector 112 will create a new perspective.

The computer system 104 is in communication with the imaging system 102. The computer system 104 provides, for instance, a user interface, control over the operation of the imaging system 102, data storage, and data processing. It will be appreciated, however, that although the imaging system 102 and the computer system 104 are shown as two discrete units in FIG. 1, the functionality of the computer system 104 can also be integrated, wholly or in part, into the imaging system 102.

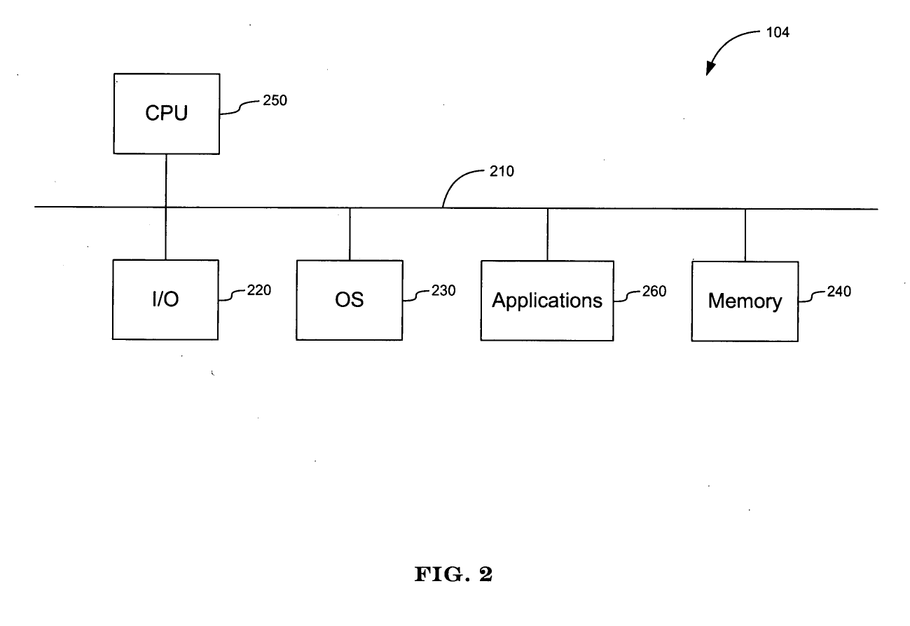

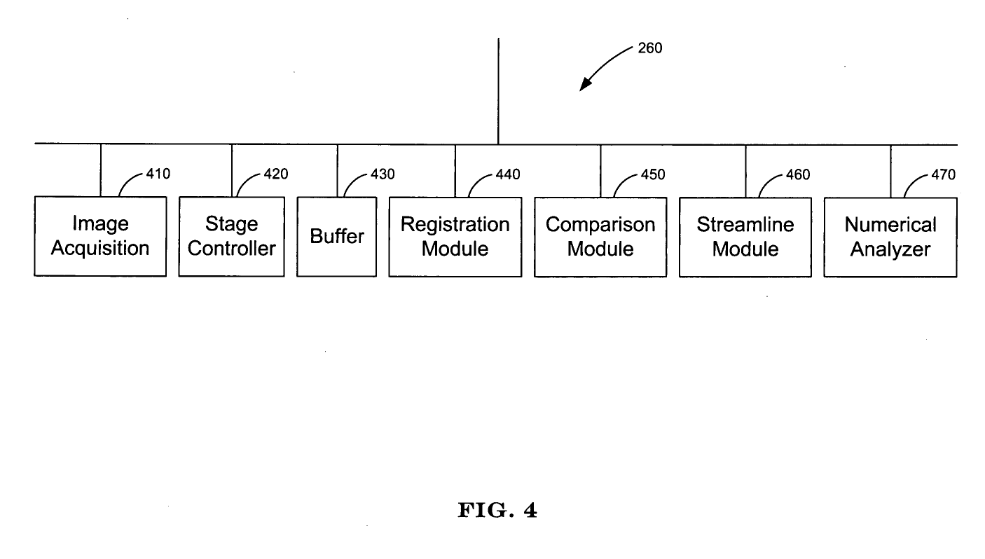

FIG. 2 is a schematic representation of some of the functional components of computer system 104 (FIG. 1). The computer system 104 comprises a bus 210 for providing communication between the various components of the computer system 104. An I/O module 220 in communication with the bus 210 permits data to be received by, and sent from, the computer system 104. An operating system 230 controls functions of the computer system 104 including scheduling tasks, allocating storage, and so forth. A memory 240 can comprise a mass storage device such as a disk drive, a random access memory such as a buffer, or combinations of both of these. A central processing unit 250 can be, for example, a microprocessor chip. The central processing unit 250 provides data processing to the operating system 230 and to applications 260. Applications 260 perform specific functions described below with reference to FIG. 4.

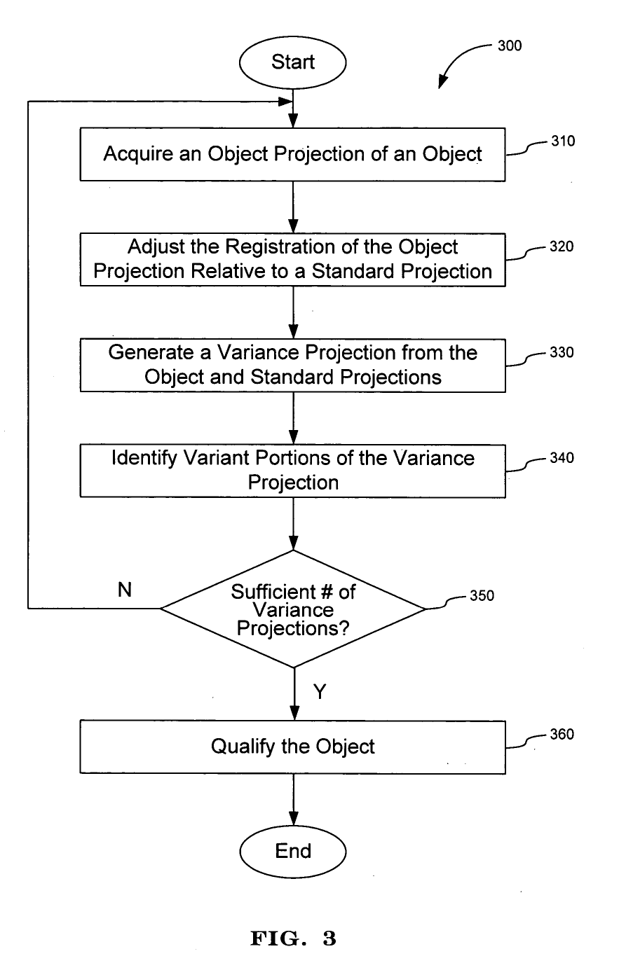

FIGS. 3 and 4 show, respectively, a flowchart representation of an exemplary method of the invention, and exemplary applications for performing the steps of the method. With reference first to FIG. 3, a method 300 for qualifying an object comprises a step 310 of acquiring an object projection of an object, a step 320 of adjusting a registration of the object projection relative to a standard projection, a step 330 of generating a variance projection from the object and standard projections, a step 340 of identifying variant portions of the variance projection, a step 350 of determining whether the number of variance projections is sufficient to assess the quality of the object, and a step 360 of qualifying the object.

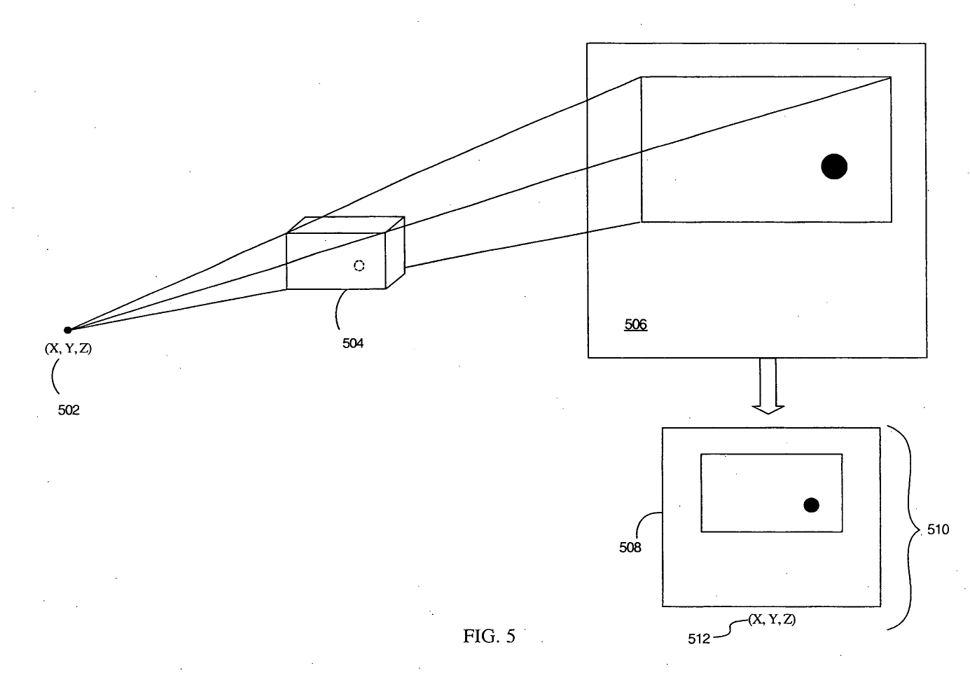

In step 310 the object projection of the object is acquired. The object projection is a projection of the object that is acquired with a specific perspective. Thus, the object projection includes a two-dimensional map of radiation intensity received at a detector and a set of positional data that define the perspective. The object projection can be acquired, as shown in FIG. 5, for example, by placing a radiation source 502 on one side of the object 504 and a suitable detector 506 on the other side of the object 504 so that the detector 506 receives and records radiation transmitted through the object 504. The detector 506 is divided into an array of receptors, or pixel sensors, that each record the intensity of the incident radiation in a localized area. In some embodiments, the pixel sensors convert incident radiation to an electric charge that can be measured and converted to a digital signal. The signal for each pixel sensor can be stored as a pixel of an intensity map component 508 of an object projection 510.

In addition to the intensity map 508, the object projection 510 also comprises positional data 512 that define the perspective. In the example illustrated by FIG. 5, positional data 512 can include locations in space of the radiation source 502 and the detector 506 relative to some frame of reference. For instance, if an origin of the frame of reference is the center of a stage (not shown), then the positional data 512 can comprise respective distances from the origin to the radiation source 502 and the detector 506 along three perpendicular axes.

It will be appreciated that in some embodiments the positional data 512 will be more conveniently represented by coordinates other than Cartesian coordinates, such as by polar coordinates. It will also be appreciated that in those embodiments in which the radiation source and the detector are maintained in a fixed relationship to one another, specifying the location of one specifies the position of the other. Also, in some embodiments, the stage can rotate, tilt, translate in one or more directions, or perform any combination of these. In such embodiments, positional data 512 should comprise the location and orientation of the stage, relative to the frame of reference, in addition to the positions of the radiation source 502 and the detector 506.

FIG. 4 provides exemplary applications for performing the steps of the method 300 described in FIG. 3. The applications shown in FIG. 4 are shown collectively as applications 260 in FIG. 2. The applications in FIG. 4 can be stored as program instructions on a computer-readable medium such as memory 240. The program instructions can also be embodied in an article of manufacture, such as a CD-ROM, which can be read by a computer system in communication with an imaging system.

In order to acquire an object projection of the object in step 310 of FIG. 3, image acquisition module 410 determines a perspective for the object projection and communicates the perspective to a stage controller module 420 that drives moveable components of the imaging system, such as the stage, the radiation source, and the detector to their appropriate locations and orientations.

Once the moveable components of the imaging system have been arranged according to the desired perspective, the image acquisition module 410 acquires an intensity map. The image acquisition module 410 can determine an appropriate data collection time for acquiring the intensity map. In some embodiments, the appropriate data collection time is a fixed value, such as equal to the data collection time used to acquire a corresponding projection of a standard. In other embodiments, the image acquisition module 410 monitors the acquisition of the intensity map in real-time to dynamically adjust the data collection time so that any under and over exposure of pixel sensors is minimized. The intensity map and the positional data that define the perspective can be stored, for example, in a buffer 430.

In step 320 of FIG. 3, a registration of the object projection is adjusted relative to the standard projection. Adjusting the registration corrects for minor variations between the positions of the object and the standard during the acquisitions of their respective projections. Such minor variations can occur, for example, due to creep in stepper motors that drive moveable components of the imaging system. While this step is optional, adjusting the registration improves the step 330 of generating a variance projection.

Adjusting the registration of the object projection relative to the standard projection can be performed, for example, by a registration module 440 (FIG. 4). To perform this function, the registration module 440 recalls the standard projection that has the same perspective as the object projection and compares the two. In some embodiments, a set of standard projections for the different perspectives is stored in a memory device such as memory 240 in FIG. 2 or an external database and the standard projection for the relevant perspective is recalled to a buffer such as the buffer 430 (FIG. 4). A simple registration adjustment compares the periphery of the object in the object projection and in the standard projection to determine a direction and a magnitude of misalignment. The registration module 440 can then translate the object projection to align it with the standard projection, or in some embodiments, translate the standard projection to align with the object projection. The corrected projection is then stored to a buffer such as the buffer 430. Similar adjustments can be made to correct for minor rotational variations. Still more complex registration adjustments can be performed based on matching common features within the object and standard projections. Algorithms for registration adjustment are well known to those of ordinary skill in the art.

In step 330 of FIG. 3 the variance projection is generated from the object and standard projections. The variance projection represents the difference between the object and standard projections. Like the standard and object projections, the variance projection includes an intensity map and positional data for the perspective that is common to the standard and object projections. If the object and the standard are essentially the same, and their respective projections were acquired under essentially the same conditions (e.g., same radiation source luminosity, etc.) then the intensity map component of the variance projection should be uniform and essentially equal to a baseline value such as zero. However, any differences between the object and the standard will create corresponding features in the intensity map component of the variance projection. In this way, defects (e.g., cracks, voids, delaminations, and dimensional differences) will become apparent in the variance projection.

Generating the variance projection in step 330 can be performed, for example, by a comparison module 450 (FIG. 4). In some embodiments, the comparison module 450 subtracts the intensity map of one projection from the intensity map of the other projection to produce the intensity map of the variance projection. It will be appreciated that more complex functions can also be applied to the intensity map of the variance projection such as averaging and smoothing functions. The comparison module 450 can also copy the positional data from either of the standard or object projections to complete the variance projection. The variance projection can be stored to a memory device such as the buffer 430.

In step 340, variant portions of the variance projection are identified, which can be achieved, for example, by a streamline module 460 in FIG. 4. A variant portion is a region of the intensity map of the variance projection that includes some significant difference between the object projection and the standard projection. The cause for the difference could be due, for instance, to a defect or anomaly in the object. In some embodiments, a portion of the intensity map of the variance projection must exceed a threshold in order to be identified as constituting a variant portion. For example, any pixel in the variance projection intensity map that exceeds a particular threshold value can be a variant portion. Alternatively, a variant portion can be defined as any portion of the intensity map in which a threshold number of pixels within a given area each exceed a threshold intensity. Threshold values, for example, can be fixed values or can be set by a user to vary the sensitivity. It will be appreciated that more complex algorithms can also be applied to identify variant portions.

In some embodiments, once the variant portion has been identified it can be described in terms of its location within the intensity map of the variance projection. For example, a circular variant portion can be described by the location of the pixel at the center and a radius value. Alternately, the circular variant portion can be described by the set of pixels that define the perimeter. This latter approach also works well for odd-shaped variant portions. Once the variant portions of the variance projection have been identified, it is unnecessary to retain remaining portions of the intensity map. Therefore, in some embodiments, the variant portions are stored to a buffer, such as the buffer 430 (FIG. 4), while the remainder of the intensity map is discarded.

In step 350, a determination is made as to whether a sufficient number of variance projections have been generated to assess the quality of the object. In some embodiments, a sufficient number is a fixed value, for example 8. In these embodiments, the fixed value of object projections will automatically be acquired for each object being inspected. From the fixed value of object projections, the fixed value of variance projections are automatically generated.

In other embodiments, an evaluation of the accumulated variance projections is made after each iteration. For example, if no variant portions are identified in the first two variance projections, then a sufficient number of variance projections have been generated to assess the quality of the object. On the other hand, if a first variance projection reveals a variant portion, and a second variance projection does not, then a sufficient number of variance projections have not been generated and the method will return to step 310. Likewise, if several variance projections each have a variant portion that correlates to the same region in the object, then again a sufficient number of variance projections may have been generated to assess the quality of the object.

In still other embodiments, the accumulated variance projections are analyzed after each iteration to determine a perspective for a subsequent variance projection. In these embodiments, the system is able to determine which additional perspective or perspectives will be most helpful to improve the resolution of a subsequent 3D reconstruction of the differences between the object and the standard. Accordingly, the imaging system can be directed to acquire an object projection with the perspective needed to generate a variance projection with the desired perspective.

If a sufficient number of variance projections have been generated to assess the quality of the object in step 350, then in step 360 the object is qualified. Qualification, in some embodiments, can include passing or failing the object. In other embodiments, qualification may comprise grading or segregating according to a particular metric. For instance, objects can be graded into categories of high quality, medium quality, and low quality based on the number of defects or a figure of merit. In some embodiments, the object is qualified based on the variance projections, for example, according to whether a sum of all of the variant portions identified in the several variance projections exceeds a threshold value.

In other embodiments, a 3D variance reconstruction of the variations between the object and the standard is generated, and the object is qualified based on the variance reconstruction. The variance reconstruction can be produced, for instance, from just the variant portions of the variance projections. Advantageously, the numbers of pixels in the variant portions of the variance projections is typically a very small fraction of the total number of pixels in the variance projections, and this substantially reduces the computation time required to generate a variance reconstruction relative to the time required to generate a 3D reconstruction of the entire object. This, in turn, allows the method of the invention to screen objects at speeds that are commensurate with assembly line speeds in industries such as the semiconductor industry.

Qualification of the object in step 360, can be performed, for example, by a numerical analyzer 470 in FIG. 4. The numerical analyzer 470 can apply a set of criteria to the variance data to determine whether the object is acceptable (e.g., Pass/Fail) or to determine a grade for the object. As noted, a simple criteria is just the total number of variant portions found amongst the several variance projections. For example, an object will fail if more than a threshold number of variant portions are counted. Qualification can likewise be based on the number of defects that are identified within the 3D variance reconstruction of the variations. In some embodiments, the numerical analyzer 470 is configured to identify different types of defects and to qualify the object based on a figure of merit derived from such criteria as the numbers, sizes, locations, and orientations of the different types of defects. For example, a void of a particular size in one location may be acceptable, while the same void in another location may be unacceptable and will cause the object to fail the inspection.

Alternatively, qualification can be performed manually by an operator. In these embodiments, a graphical user interface can provide variance data to the operator. For example, a graphics generator of the numerical analyzer 470 can superimpose the variance reconstruction of the variations over a stored 3D reconstruction of the standard to provide the operator with a visual indication of the differences between the object and the standard. The composite of the standard and variance reconstructions can be enhanced, for example through the use of colors or shading, to highlight defects for the operator. It will be appreciated that such graphics can also be displayed while object qualification is being determined automatically by the numerical analyzer 470.

It will be understood that the exemplary applications shown in FIG. 4 for performing the steps of the method described in FIG. 3 are merely exemplary and can be readily combined or subdivided. For example, in some embodiments the numerical analyzer 470 also performs the task in step 350 of determining whether a sufficient number of variance projections have been generated to assess the quality of the object.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

1. A method for producing a variance reconstruction of variations between an object and a standard comprising:
acquiring object projections of the object from a plurality of different perspectives;
generating variance projections from the object projections by comparing the object projections with stored standard projections having corresponding perspectives; and
generating the variance reconstruction from the variance projections.

2. The method of claim 1 wherein the object projections each comprise a two-dimensional map of radiation intensity and a set of positional data that define the perspective of the object projection.

3. The method of claim 2 wherein the two-dimensional map of radiation intensity comprises a two-dimensional map of X-ray radiation intensity.

4. The method of claim 1 wherein comparing the object projections with stored standard projections having corresponding perspectives comprises determining differences between the corresponding object and standard projections.

5. The method of claim 1 wherein generating the variance reconstruction from the variance projections comprises identifying variant portions of the variance projections.

6. The method of claim 5 wherein identifying variant portions comprises comparing intensity maps of the variance projections to a threshold.

7. The method of claim 5 wherein identifying variant portions comprises describing the locations of the variant portions within the intensity maps.

8. The method of claim 7 wherein describing the location of a variant portion comprises identifying pixels that define a perimeter of the variant portion.

9. The method of claim 1 further comprising adjusting registrations of the object projections relative to the standard projections having corresponding perspectives before generating variance projections.

10. A method for automated tomography inspection comprising:
acquiring object projections of an object from a plurality of different perspectives;
generating variance projections from the object projections by comparing the object projections with stored standard projections having corresponding perspectives; and
evaluating the variance projections to qualify the object.

11. The method of claim 10 wherein the object projections each comprise a two-dimensional map of radiation intensity and a set of positional data that define the perspective of the object projection.

12. The method of claim 11 wherein the two-dimensional map of radiation intensity comprises a two-dimensional map of X-ray radiation intensity.

13. The method of claim 10 wherein generating variance projections comprises determining whether a sufficient number of variance projections have been acquired to assess the quality of the object.

14. The method of claim 10 wherein evaluating the variance projections to qualify the object comprises passing or failing the object.

15. The method of claim 10 wherein evaluating the variance projections to qualify the object comprises grading the object.

16. The method of claim 10 wherein evaluating the variance projections to qualify the object comprises generating a variance reconstruction of the variations between the object and the standard.

17. The method of claim 16 wherein generating the variance reconstruction comprises determining variant portions of the variance projections.

18. The method of claim 16 wherein evaluating the variance projections to qualify the object comprises evaluating the variance reconstruction.

19. The method of claim 18 wherein evaluating the variance reconstruction comprises identifying defects in the variance reconstruction.

20. The method of claim 19 wherein evaluating the variance reconstruction comprises determining a figure of merit from the defects identified in the variance reconstruction.

21. A computer-readable medium comprising program instructions for
acquiring object projections of an object from a plurality of different perspectives;
generating variance projections from the object projections by comparing the object projections with stored standard projections having corresponding perspectives; and
generating a variance reconstruction from the variance projections.

22. The computer-readable medium of claim 21 further comprising program instructions for adjusting registrations of the object projections relative to the standard projections having corresponding perspectives.

23. A computer-readable medium comprising program instructions for
acquiring object projections of an object from a plurality of different perspectives;
generating variance projections from the object projections by comparing the object projections with stored standard projections having corresponding perspectives;
evaluating the variance projections to qualify the object.

24. The computer-readable medium of claim 23 further comprising program instructions for generating a variance reconstruction of the variations between the object and the standard.

25. The computer-readable medium of claim 23 further comprising program instructions for determining variant portions of the variance projections.

26. The computer-readable medium of claim 25 further comprising program instructions for generating a variance reconstruction of the variations between the object and the standard from the variant portions of the variance projections.

27. An apparatus for producing a variance reconstruction of variations between an object and a standard comprising:
an imaging system including
a stage for supporting the object, and
a radiation source and a detector adjustably positionable relative to the object to define perspectives thereof; and
a computer system in communication with the imaging system and configured to
acquire object projections of the object from a plurality of different perspectives,
generate variance projections from the object projections by comparing the object projections with stored standard projections having corresponding perspectives, and
generate the variance reconstruction from the variance projections.

28. The apparatus of claim 27 wherein the computer system is further configured to adjust registrations of the object projections relative to the standard projections having corresponding perspectives.

29. The apparatus of claim 27 wherein the computer system is further configured to evaluate the variance reconstruction to qualify the object.

30. An apparatus for producing a variance reconstruction of variations between an object and a standard comprising:
means for acquire object projections of the object from a plurality of different perspectives,
means for generate variance projections from the object projections by comparing the object projections with stored standard projections having corresponding perspectives, and
means for generate the variance reconstruction from the variance projections.
